(19) United States
(12) Patent Application Publication
(10) Pub. No.: US 2026/0333181 A1
(43) Pub. Date: Oct. 22, 2026

(54) SELECTION OF A CONDITIONAL LTM CANDIDATE CELL

(71) Applicant: TELEFONAKTIEBOLAGET LM ERICSSON (PUBL), Stockholm (SE)

(72) Inventors: Antonino Orsino, KIRKKONUMMI (FI); Jens Bergqvist, Linköping (SE); Icaro Leonardo Da Silva, SOLNA (SE); Cecilia Eklöf, TÄBY (SE); Luca Lunardi, Genova (IT)

(21) Appl. No.: 19/697,729

(22) Filed: Jun. 4, 2026

Related U.S. Application Data
(63) Continuation of application No. PCT/EP2025/063954, filed on May 21, 2025.
(60) Provisional application No. 63/651,472, filed on May 24, 2024.

(51) Int. Cl. H04W 36/36; H04W 56/00

(52) U.S. Cl. CPC H04W 36/362; H04W 56/0045

(57) ABSTRACT

A method performed by a user equipment (UE) for selecting a conditional L1/L2 triggered inter-cell mobility (CLTM) candidate cell. The method includes receiving (1502), from a network node, a CLTM configuration for multiple CLTM candidate cells, where the CLTM configuration includes at least one or more CLTM candidate cell configurations and at least one or more CLTM execution conditions. The method further includes determining (1504) whether at least one CLTM execution condition is fulfilled for the CLTM candidate cell. In response to there being more than one triggered CLTM candidate cell, the method includes selecting (1506) one of the triggered CLTM candidate cells for CLTM execution, wherein the selected cells are selected based on one or more selection criteria. Related network node methods, UEs, and network nodes, are also disclosed.

### RELATED APPLICATIONS

The present application is a continuation of International Application No. PCT/EP2025/063954, filed May 21, 2025, which claims priority to U.S. Provisional Patent Application No. 63/651,472, filed May 24, 2024, entitled “SELECTION OF A CONDITIONAL LTM CANDIDATE,” the disclosures of which are hereby incorporated herein by reference in their entirety.

### TECHNICAL FIELD

The present disclosure relates to a method performed by a user equipment (UE) for selecting a conditional L1/L2 triggered inter-cell mobility (CLTM) candidate cell, a method performed by a network node for supporting CLTM, a UE for selecting a CLTM candidate cell, and a network node for supporting CLTM.

### BACKGROUND

In a typical wireless communication network, wireless devices, also known as wireless communication devices, mobile stations, stations (STA) and/or User Equipment (UE), communicate via a Wide Area Network or a Local Area Network such as a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node, e.g., a Base Station (BS) or a radio base station (RBS), which in some networks may also be denoted, for example, a Base Station (BS), a NodeB, eNodeB (eNB), or gNodeB (gNB) as denoted in 3GPP Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G. also called a Fourth Generation (4G) network, EPS is the core network and E-UTRA is the radio access network. In 5G, 5GC is the core network, and NR is the radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1. Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which further increases the cell capacity. This may be referred to as Multi-User (MU)-MIMO. Note that MU-MIMO may be beneficial even when each UE only has one antenna. The cell capacity can be increased linearly with respect to the number of antennas at the BS side. Due to that, more and more antennas are employed in BS. Such systems and/or related techniques are commonly referred to as massive MIMO.

### L1/L2 Inter-Cell Mobility or L1/L2 Triggered Inter-Cell Mobility (LTM) in Rel-18

In Release 18, 3GPP has agreed on a Work Item on further New Radio (NR) mobility enhancements, in particular, in a technical area entitled L1/L2 based inter-cell mobility (see “New WID on Further NR mobility enhancements”, R3-233495, 3GPP TSG-RAN WG3 #120 , Incheon, 22-26 May 2023, for further details).

According to the WID, when the UE moves from the coverage area of one cell to another cell, at some point a serving cell change needs to be performed. Currently, a serving cell change is triggered by L3 measurements and is done by RRC signaling triggered Reconfiguration with Synchronization for a change of PCell and PSCell, as well as release/add for SCells when applicable. All cases involve complete L2 (and L1) resets, leading to longer latency, larger overhead, and longer interruption time than beam switch mobility. The goal of L1/L2 mobility enhancements is to enable a serving cell change via L1/L2 signaling, in order to reduce the latency, signaling overhead, and interruption time.

As part of L1-L2 inter-cell mobility measurement framework, it was agreed to support at least L1-Reference Signal Received Power (L1-RSRP) as the reporting quantity. That means the UE is required to report L1-RSRP of the candidate cells to the network so that the network can use them for LTM handover (HO) decisions.

In Release 17, as part of inter-cell beam management, a solution has been standardized where L1-RSRP is measured and reported on a Channel Status Information (CSI) resource that is not associated to a Physical Cell Identity (PCI) of the serving cells.

### L3 HO Procedure vs. LTM HO Procedure From Total Delay Perspective

The below is reproduced from 3GPP TS 38.133 V18.0.0 (2022-12) (Technical Specification; 3rd Generation Partnership Project; Technical Specification Group Radio Access Network; NR; Requirements for support of radio resource management (Release 18)).

### *** START 3GPP TS 38.133 V18.0.0 (2022-12) ***

6.1.1.2.1 Handover delay
When the UE receives an RRC message implying handover, the UE shall be ready to start the transmission of the new uplink PRACH channel within D_{handover} msec from the end of the last TTI containing the RRC command.

### Where:

D_{handover} equals the applicable RRC procedure delay defined in clause 12 in TS 38.331 [2] plus the interruption time stated in clause 6.1.1.2.2

### 6.1.1.2.2 INTERRUPTION TIME

The interruption time is the time between end of the last TTI containing the RRC command on the old PDSCH and the time the UE starts transmission of the new PRACH, excluding the RRC procedure delay.
When intra-frequency or inter-frequency handover is commanded, the interruption time shall be less than T^{interrupt}

Tᵢₙₜₑᵣᵣᵤₚₜ=T_{search}+T_{IU}+T_{processing}+T_{Δ}+T_{margin} ms

### Where:

T_{search} is the time required to search the target cell when the target cell is not already known when the handover command is received by the UE. If the target cell is known, then T_{search}=0 ms. If the target cell is an unknown intra-frequency cell and the target cell Es/Iot≥−2 dB, then T_{search}=Tᵣₛ ms. If the target cell is an unknown inter-frequency cell and the target cell Es/Iot≥−2 dB, then T_{search}=3*Tᵣₛ ms. Regardless of whether DRX is in use by the UE, T_{search} shall still be based on non-DRX target cell search times.
T_{Δ} is time for fine time tracking and acquiring full timing information of the target cell.
T_{Δ}=Tᵣₛ for both known and unknown target cell.
T_{processing} is time for UE processing. T_{processing} can be up to 20 ms.
T_{margin} is time for SSB post-processing. T_{margin} can be up to 2 ms.
T_{IU} is the interruption uncertainty in acquiring the first available PRACH occasion in the new cell. T_{IU} can be up to the summation of SSB to PRACH occasion association period and 10 ms. SSB to PRACH occasion associated period is defined in the table 8.1-1 of TS 38.213 [3].
Tᵣₛ is the SMTC periodicity of the target NR cell if the UE has been provided with an SMTC configuration for the target cell in the handover command, otherwise Trs is the SMTC configured in the measObjectNR having the same SSB frequency and subcarrier spacing. If the measObjectNRs having the same SSB frequency and subcarrier spacing configured by MN and SN have different SMTC, Trs is the periodicity of one of the SMTC which is up to UE implementation. If the UE is not provided SMTC configuration or measurement object on this frequency, the requirement in this clause is applied with Tᵣₛ=5 ms assuming the SSB transmission periodicity is 5 ms. There is no requirement if the SSB transmission periodicity is not 5 ms. If the UE has been provided with higher layer in TS 38.331 [2] signaling of smtc2 prior to the handover command, Tᵣₛ follows smtc1 or smtc2 according to the physical cell ID of the target cell.

In the interruption requirement a cell is known if it has been meeting the relevant cell identification requirement during the last 5 seconds otherwise it is unknown. Relevant cell identification requirements are described in Clause 9.2.5 for intra-frequency handover and Clause 9.3.4 for inter-frequency handover.

### *** END 3GPP TS 38.133 V18.0.0 (2022-12) ***

As per the above requirements, L3 HO delay (D_{handover}) equals the RRC processing delay of the HO command and the interruption time, where the interruption time comprises of the following components:
SW and HW processing
Cell search
Acquisition of fine timing
Delay uncertainty of obtaining PRACH preamble

### Conditional Handover (CHO)

In Rel-16, CHO was standardized. In CHO, the UE is configured with execution conditions and handover target configurations. The UE monitors the execution conditions and when the conditions are fulfilled, the UE applies the configuration of the target cell. The target configuration was prepared in advance, which makes the execution of the handover faster and with less risk of failures. When the UE executes the CHO or a regular handover, all (other) conditional reconfigurations are released. FIG. 1 shows a signaling diagram of a CHO execution.

In Rel-19, Conditional LTM (CLTM) will be specified. In this case, the UE will be configured with one or more conditional LTM candidate cell(s), each conditional LTM candidate cell having i) an LTM candidate configuration (to be applied during LTM execution) and a conditional LTM execution condition that the UE evaluates, such as a measurement of a conditional LTM candidate cell (e.g., RSRP of ‘best’ beam of the LTM candidate cell) becomes an offset better than a measurement of a serving cell (e.g., RSRP of ‘best’ beam of the PCell). In conditional LTM, when the conditional LTM execution condition is fulfilled, the UE applies the associated LTM candidate configuration. As part of the CLTM preparation, the UE receives for each conditional LTM candidate cell i) the LTM candidate configuration (to be applied during LTM execution) and the conditional LTM execution condition.

However, as the UE may be configured with multiple LTM candidate cell(s), it may happen that multiple LTM candidate cells have their conditional LTM execution conditions fulfilled. These CLTM candidate cells may be called “triggered CLTM candidate cells”, among the CLTM candidate cells. When that occurs, the UE needs to select one of the LTM candidate cell(s) for applying the conditional LTM execution condition.

### SUMMARY

Certain aspects of the disclosure and their embodiments may provide solutions to these or other challenges. The disclosed subject matter describes how a UE selects a conditional LTM candidate (CLTM) cell in response to there being more than one triggered CLTM candidate cell.

Some embodiments provide a method performed by a user equipment (UE) for selecting a conditional L1/L2 triggered inter-cell mobility (CLTM) candidate cell. The method comprises receiving, from a network node, a CLTM configuration comprising two or more CLTM candidate cell configurations and associated CLTM execution conditions. The method further comprises determining whether at least two CLTM execution conditions are fulfilled. The method further comprises, in response to there being more than one CLTM candidate cell for which the CLTM execution condition is fulfilled, selecting one of the CLTM candidate cells for which the CLTM execution conditions are fulfilled for CLTM execution. The CLTM candidate cell is selected based on one or more selection criteria.

Some embodiments provide a method performed by a network node for a supporting CLTM. The method comprises transmitting, from the network node to a UE, a CLTM configuration comprising two or more CLTM candidate cell configurations and associated CLTM execution conditions.

Some embodiments provide a UE for selecting a CLTM candidate cell. The UE comprises processing circuitry configured to perform any of the steps performed by the UE, and a power supply circuitry configured to supply power to the processing circuitry.

Some embodiments provide a network node for supporting CLTM. The network node comprises processing circuitry configured to perform any of the steps performed by the network node, and a power supply circuitry configured to supply power to the processing circuitry.

In some embodiments the one or more selection criteria are based on one of more of:
The one or more configurations of the CLTM candidate cells for which the associated CLTM execution conditions are fulfilled.
One or more physical layer properties of the CLTM candidate cells for which the associated CLTM execution conditions are fulfilled.
An interruption time of a CLTM candidate cell for which the associated CLTM execution condition is fulfilled during CLTM execution.
One or more radio conditions and/or one or more measurements of CLTM candidate cells for which the associated CLTM execution conditions are fulfilled.
Frequency information of CLTM candidate cells for which the associated CLTM execution conditions are fulfilled and/or the SpCell.

In some embodiments, selecting one of the triggered CLTM candidate cells for CLTM execution comprises applying the CLTM candidate cell configuration for the selected CLTM candidate cell.

Selecting a CLTM candidate cell among the triggered cells for CLTM execution (i.e., the CLTM candidate cells for which the associated CLTM execution conditions are fulfilled) without the proper care may lead to problems such as:
The UE selects a conditional LTM candidate cell which is not necessarily the cell the network would have preferred (e.g., not the intended frequency and/or not the strongest cell with the intended frequency) so that, after applying the conditional LTM candidate configuration and accessing that conditional LTM candidate cell, the UE triggers an A3 event and transmits a measurement report, in response to which it receives a handover command to another cell (which could have been possibly selected among the triggered CLTM candidate cells). This leads to unnecessary of signaling which consumes power/energy at the UE and increases the interruption time and disrupts service continuity.
The UE selects a conditional LTM candidate cell and, after applying the conditional LTM candidate configuration and accessing that conditional LTM candidate cell, the UE transmits a lower layer measurement to the network, after which the UE may receive an LTM Cell Switch command from the network indicating to the UE to switch to the other conditional LTM candidate configuration for which the associated CLTM execution conditions has been fulfilled. In this case, the UE may have directly performed a conditional LTM execution to the other conditional LTM candidate configuration without increasing the signalling overhead, UE power consumption, and connectivity interruption.
The UE selects a conditional LTM candidate cell and, after applying the conditional LTM candidate configuration and accessing that conditional LTM candidate cell, the UE transmits a lower layer measurement to the network, and the UE may experience radio link problems (e.g., Radio Link Failure—RLF, mobility failure, etc.) and perform RRC re-establishment. In this case, the UE may have been directly selected to perform a conditional LTM execution to the other conditional LTM candidate configuration without incurring connectivity interruption, power consumption, and signalling overhead.

In order to address the above challenges, some embodiments present a method to be implemented in a User Equipment (UE) for selecting a conditional LTM (CLTM) candidate cell from one or more conditional LTM candidate (CLTM) cell(s) for which the respective conditional LTM execution condition(s) have been fulfilled. In other words, the UE selects a cell among multiple triggered CLTM candidate cells, wherein a triggered CLTM cell is a CLTM candidate cell for which the associated CLTM execution condition has been fulfilled. For the selected triggered CLTM candidate cell, the UE applies the associated CLTM candidate cell configuration and performs the Conditional LTM execution procedure.

One overall benefit is that the UE may choose a conditional LTM candidate cell which is stable over time and thus to reduce the risk to perform further LTM cell switch or, in general, mobility procedures, or even a radio link failure, shortly after the CLTM execution.

Further, the UE saves power/energy, because the UE avoids exchanging unnecessary signaling between the UE and the network. In addition, a side effect is a potential gain in robustness since mobility procedures (e.g., handover, LTM cell switches, or CHO executions) shortly after a conditional LTM cell switch execution is an indication that the applied configuration for the selected cell is not the best, which might mean some risk of radio link failures, handover failures, LTM cell switch failures, or CHO execution failures.

In the method, the UE determines that there are multiple triggered CLTM candidate cells among the configured CLTM candidate cells and, in response to that, selects one of the CLTM candidate cells among the triggered CLTM candidate cells, and applies the conditional LTM candidate cell configuration for the selected cell, wherein the selection of the CLTM is according to one or more rules. Or, in other words, when there is more than one conditional LTM candidate cell which fulfill the CLTM execution condition, the UE selects one CLTM candidate cell to determine which candidate LTM candidate configuration to apply in order to perform a conditional LTM cell switch execution procedure.

### BRIEF DESCRIPTION OF THE DRAWINGS

FIG. 1 illustrates a flow chart of a UE moving from one gNB-DU to another gNB-DU within the same gNB-CU during NR operation for LTM.

FIG. 2illustrates a method performed by a UE in a wireless communication network for performing TA with a LTM candidate cell according to some embodiments.

FIG. 3 illustrates a method performed by a network node in a wireless communication network for L1/L2 based inter-cell mobility of a UE to a candidate cell according to some embodiments.

FIG. 4 shows an example of a communication system in accordance with some embodiments.

FIG. 5 shows an example of a UE in accordance with some embodiments.

FIG. 6 shows an example of a network node in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

This disclosure refers to the term “L1/L2 based inter-cell mobility” as used in the Work Item Description in 3GPP (“Further NR Mobility Enhancements”, RP-233970, 3GPP TSG RAN Meeting #102, Edinburgh, Scotland, December 11-15, 2023), though it interchangeably also uses the terms L1/L2 mobility, L1-mobility, L1 based mobility, L1/L2-centric inter-cell mobility, L1/L2 inter-cell mobility, or L1/L2 triggered Mobility (LTM).

### L1/L2 Based Inter-Cell Mobility in Rel-18

A basic principle with L1/L2-triggered mobility, also called L1/L2 Triggered Mobility (LTM) is that the UE is pre-configured, by the network, with an RRC configuration per LTM candidate cell, sometimes also known as a LTM candidate cell configuration. Such an LTM candidate cell configuration may be an RRC Reconfiguration message or one or more IEs/fields/parameters such as CellGroupConfig which is stored when the UE is configured with LTM. The UE transmits lower layer measurements (e.g., L1-RSRP) on these candidate LTM candidate cells to the network. In response, the UE receives from the network a lower layer signal (such as a MAC CE or DCI) to trigger the execution of LTM cell switch in the UE, sometimes also referred to as a LTM cell switch command. In response, the UE accesses the LTM candidate cell indicated in the LTM cell switch command and switches to a configuration of an LTM candidate cell. When the UE is configured with multiple LTM candidate cells, the UE receives multiple LTM candidate cell configuration(s), e.g., multiple RRC Reconfiguration messages to be stored, each associated to an LTM candidate ID which may be later referred in the LTM cell switch command the UE may receive, to indicate to which of the LTM candidate cells the UE needs to perform the LTM cell switch.

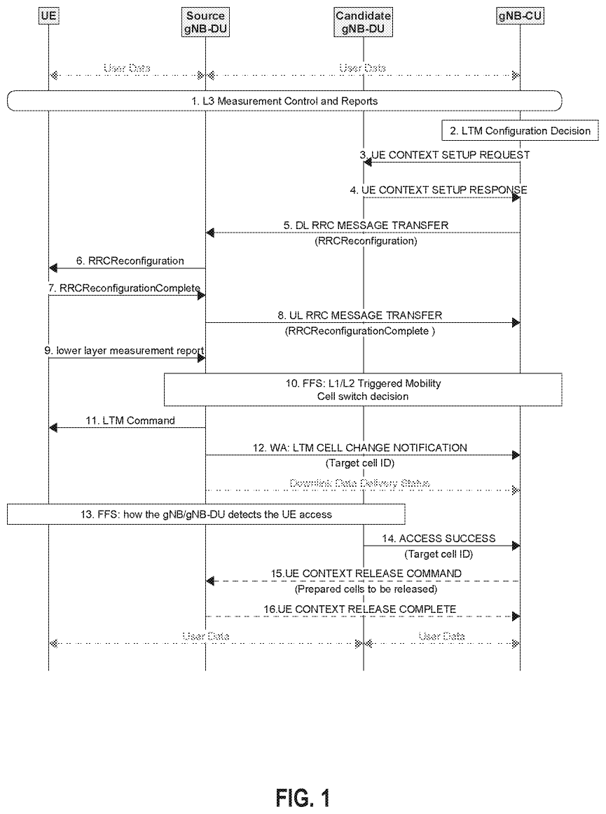

In Rel-18, LTM is supported in a Central Unit (CU)/Distributed Unit (DU) split architecture, in which a gNodeB may be split into a CU and a DU, and an LTM candidate cell may either be from the Source DU (S-DU), denoted as the “same DU” of the UE's current serving cell(s), e.g., the Master Cell Group, or from a “neighbour DU”, denoted Candidate DU (C-DU), associated to the same CU. Thereby, LTM in Rel-18 supports intra-CU intra-/inter-DU cases. A summary of the preparation procedures is shown below only for the inter-DU case, for simplicity, as captured in R 3-233495 (“TP for LTM BL CR to TS 38.401”, 3GPP TSG-RAN WG 3 #120 , Incheon, 22-26 May 2023). The procedure is used for the case when the UE moves from one gNB-DU to another gNB-DU within the same gNB-CU during NR operation, which for LTM is illustratively shown in FIG. 1 (which is reproduced from R3-233495). In FIG. 1, the steps are the following (FFS indicates that some details are “for further studies”, i.e., not yet decided):
1. The UE sends a MeasurementReport message (L3 measurement result FFS) to the source gNB-DU containing measurements of neighboring cells. The source gNB-DU sends an UL RRC MESSAGE TRANSFER message conveying the received MeasurementReport message to the gNB-CU.
2. The gNB-CU determines to initiate LTM configuration.
3. The gNB-CU sends a UE CONTEXT SETUP REQUEST message to the candidate gNB-DU, containing one target candidate cell ID.
4. If the candidate gNB-DU accepts the request of LTM configuration, it responds to the gNB-CU with a UE CONTEXT SETUP RESPONSE message including the generated lower layer RRC configuration for the accepted target candidate cell.
5. The gNB-CU sends a DL RRC MESSAGE TRANSFER message to the source gNB-DU, which includes the generated RRCReconfiguration message with the LTM configuration.
   FFS: whether it is DL RRC MESSAGE TRANSFER message or UE CONTEXT MODIFICATION REQUEST message.
6. The source gNB-DU forwards the received RRCReconfiguration message to the UE.
7. The UE responds to the source gNB-DU with an RRCReconfigurationComplete message.
8. The source gNB-DU forwards the RRCReconfigurationComplete message to the gNB-CU via an UL RRC MESSAGE TRANSFER message.
   FFS: whether it is UL RRC MESSAGE TRANSFER message or UE CONTEXT MODIFICATION RESPONSE message.
9. The UE sends the lower layer measurement result to the source gNB-DU.
10.The source gNB-DU decides to execute LTM to a candidate target cell.
   FFS: Notifying the LTM triggering decision to the other nodes as well.
11.The source gNB-DU sends LTM command to the UE.
12.The source gNB-DU sends the LTM CELL CHANGE NOTIFICATION message to the gNB-CU to indicate the initiation of the LTM command to the UE including the target cell ID.
13.The target gNB-DU sends the ACCESS SUCCESS message to the gNB-CU with the target cell ID.
14.The gNB-CU may send the UE CONTEXT RELEASE COMMAND message to the source gNB-DU to release the resources of prepared cells.
15.The source gNB-DU responds with a UE CONTEXT RELEASE COMPLETE message.

A lower layer protocol refers to a lower layer protocol in the air interface protocol stack compared to RRC protocol. For example, Medium Access Control (MAC) is considered a lower layer protocol as it is “below” RRC in the air interface protocol stack, and in this case a lower layer signaling/message may correspond to a MAC Control Element (MAC CE). Another example of lower layer protocol is the Layer 1 (or Physical Layer, L1), and in this case a lower layer signaling/message may correspond to a Downlink Control Information (DCI). Signaling information in a protocol layer lower than RRC reduces the processing time and, consequently, reduces the interruption time during mobility. In addition, it may also increase the mobility robustness as the network may respond to faster changes in the channel conditions. Another relevant aspect in L1/L2 inter-cell mobility is that in a multi-beam scenario, a cell can be associated to multiple Synchronization Signal Blocks (SSBs), and during a half-frame, different SSBs may be transmitted in different spatial directions (i.e., using different beams, spanning the coverage area of a cell). Similar reasoning may be applicable to CSI-Reference Signal (CSI-RS) resources, which may also be transmitted in different spatial directions. Hence, in L1/L2 inter-cell mobility (LTM), the reception of a lower layer signaling indicates the UE to change from one beam in the serving cell, to another beam in a neighbor cell (which is a configured candidate cell), and by that changing the serving cell.

The term LTM cell switch procedure (or simply cell switch) refers to the process of a UE changing its cell from a source cell to a target cell (which may be called here a candidate cell), using L1/L2-triggered mobility (also called here LTM). In the context of L1/L2 based inter-cell mobility or L1/L2-triggered mobility (LTM), the LTM cell switch procedure may sometimes also be referred to as dynamic switch, LTM switch, LTM cell switch, LTM serving cell change, or LTM cell change. Even if the term change of cell is used, that may comprise a change of a whole cell group configuration, which includes a change in the SpCell (e.g., change of PCell, or change of PSCell) and a change in SCells of the cell group (e.g., addition, modification and/or release of one or more SCells).

This disclosure refers to the term “LTM candidate cell” to refer to a cell the UE is configured with when configured with L1/L2 inter-cell mobility. That is a cell the UE can move to in a L1/L2 inter-cell mobility procedure, upon reception of a lower layer signaling. These cells may also be called candidate cells, candidates, mobility candidates, non-serving cells, additional cells, etc. This is a cell the UE performs measurements on (e.g., L1-RSRP measurements or CSI measurements) as disclosed herein, so that the UE reports these measurements and the network may take an educated decision on which beam (e.g., TCI state) and/or cell the UE is to be switched to. A L1/L2 inter-cell mobility candidate cell may be a candidate to be a target PCell, PSCell, or an SCell of a cell group (e.g., Master Cell Group (MCG) SCell). In that sense, when the text refers to a resource configuration to indicate Synchronization Signals (SSs) and/or Reference Signals (RSs) for the UE to measure for CSI for reporting, it may be referring to SSs and/or RSs of a candidate SCell of the MCG, a candidate SCell of the Secondary Cell Group (SCG), a candidate PSCell and/or a candidate PCell.

### Conditional Handover (CHO)

In Release 16, Conditional Handover was specified. CHO may be defined as a handover that is executed by the UE when one or more handover execution conditions are met. The UE starts evaluating the execution condition(s) upon receiving the CHO configuration, and stops evaluating the execution condition(s) once a handover is executed.

As in LTM, the CHO configuration contains the configuration of CHO candidate cell(s) generated by the candidate gNB(s) and execution condition(s) generated by the source gNB. Thus, as in LTM, the UE is also configured with a so-called candidate cell, in this case, a CHO candidate cell.

The so-called CHO candidate cell configuration may be represented by an RRC Reconfiguration message which is applied when the UE performs a CHO execution procedure, upon fulfillment of the CHO execution condition. Such CHO execution condition may consist of one or two trigger condition(s) (CHO events A3/A5, condEventA3 and condEventA5, see 3GPP TS 38.331 v18.1.0(2024 -03); Technical Specification; 3rd Generation Partnership Project; Technical Specification Group Radio Access Network; NR; Radio Resource Control (RRC) protocol specification (Release 18)) Only single RS type is supported and at most two different trigger quantities (e.g., RSRP and RSRQ, RSRP and SINR, etc.) can be configured simultaneously for the evaluation of CHO execution condition of a single candidate cell.

According to embodiments of the invention, the selecting one of the triggered CLTM candidate cells for CLTM is based on one or more rules which may be grouped as follows:
depending on one or more configuration(s) of the CLTM candidate cell(s); and/or
depending on one or more physical layer properties of the CLTM candidate cell(s); and/or
depending on an interruption time a triggered CLTM candidate cell would have in CLTM execution; and/or
depending on one or more radio conditions and/or one or more measurements of the CLTM candidate cell(s); and/or
depending on a frequency information of the CLTM candidate cells and/or the SpCell.

When the UE performs one or more steps of a conditional LTM cell switch procedure for the selected cell, the UE applies the stored conditional LTM candidate cell configuration associated to the selected cell and transmits, in the selected cell, a notification message (e.g. RRC Reconfiguration Complete).

This disclosure refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility L1/L2-Triggered Mobility, Lower-layer triggered Mobility or LTM.

This disclosure mentions conditional LTM, which may be seen as a conditional reconfiguration in which execution conditions are associated to the evaluation of conditions associated to lower layer measurements, e.g., Layer 1 (L1) RSRP and/or SS-RSRP, based on SSB(s) and/or CSI-RSs of a serving cell and/or of an LTM candidate cell. In this context, a conditional LTM (CLTM) uses an execution condition (or conditional LTM execution condition) or a combination of multiple executing conditions, that is/are evaluated, and when fulfilled, results in that the UE performs an action, such as executing the conditional reconfiguration (sometimes referred to as executing the condition) or conditional LTM, e.g., applying a message (CLTM candidate cell configuration, like an RRC Reconfiguration message), parts of a message (e.g., IE(s), parameters, and/or fields, such as CellGroupConfig) or at least one information element, or performing a serving cell switch or change. Known existing examples of conditional reconfiguration are conditional handover (CHO), Conditional PSCell Change (CPC), and Conditional PSCell Addition (CPA). According to embodiments of the invention, upon fulfillment of the execution condition(s) the UE performs an LTM Cell Switch.

This disclosure refers to an LTM candidate cell for conditional LTM, which may be called a conditional LTM candidate cell or simply candidate cell; or L1/L2 inter-cell mobility candidate cell or target candidate cell for L1/L2 inter-cell mobility to refer to a cell the UE is configured with when configured with conditional L1/L2 inter-cell mobility. This is a cell the UE moves to or switches to in the execution of a conditional L1/L2 inter-cell mobility procedure upon fulfillment of the associated execution condition. These cells may also be called candidate cells, candidates, mobility candidates, non-serving cells, additional cells, deactivated cells, target candidate cell, target candidate, etc. An LTM candidate cell may be a candidate to be a target Pcell or PSCell, or an Scell of a cell group (e.g., MCG Scell). In accordance with embodiments of the invention, the UE receives an LTM candidate cell configuration for conditional LTM, for an LTM candidate cell. The LTM candidate cell configuration may be received in the form of an RRC Reconfiguration message (e.g., RRCReconfiguration) which the UE stores and applies upon fulfillment of the conditional LTM execution condition associated to that LTM candidate cell. The LTM candidate cell configuration contains parameters the UE uses to operate in the associated LTM candidate cell when the UE moves to it in an LTM Cell switch. The LTM candidate cell configuration may be applied on top of the UE's current configuration and/or on top of a reference configuration (also received by the UE, e.g., as part of a conditional LTM configuration).

In accordance with embodiments of the invention, the UE receives a conditional LTM (CLTM) execution condition or conditional criteria, e.g., associated to an identifier of a measurement configuration (such as an LTM CSI reporting configuration ID). This may correspond to the UE receiving an indication of a conditional LTM execution condition and/or one or more parameters for configuring a conditional LTM execution condition, e.g., event identifier, offset(s), threshold(s), reference signal type, trigger quantity, time to trigger, etc. Examples of CLTM execution conditions are:
Quality of CLTM candidate cell (e.g., cell based RSRP, based on SSB) becomes an offset (or threshold) better than the quality of the SpCell (e.g., cell based RSRP, based on SSB)
Quality of strongest beam (e.g., SSB or CSI-RS) of a candidate cell (e.g., highest beam-based RSRP of the CLTM candidate cell) becomes an offset (or threshold) better than the quality of highest beam (e.g., SSB or CSI-RS) of the SpCell (e.g., highest beam-based RSRP of the SpCell, or RSRP of SSB configured as Quasi-Co-Location source of an activated or indicated TCI state of the SpCell)
Quality of CLTM candidate cell (e.g., cell based RSRP, based on SSB) becomes better (e.g., higher) than a threshold AND the quality of the SpCell (e.g., cell based RSRP, based on SSB) becomes lower than a threshold
Quality of strongest beam (e.g., SSB or CSI-RS) of a candidate cell (e.g., highest beam-based RSRP of the CLTM candidate cell) becomes higher than a threshold AND the quality of strongest beam (e.g., SSB or CSI-RS) of the SpCell (e.g., highest beam-based RSRP of the SpCell, or RSRP of SSB configured as Quasi-Co-Location source of an activated or indicated TCI state of the SpCell) becomes worse (e.g., lower) than a threshold.

In CLTM, in response to the CLTM execution condition being fulfilled, the UE performs the CLTM execution, which comprises applying the CLTM candidate cell configuration. It may be said that the UE performs an LTM Cell Switch in this case, in response to the fulfillment of the CLTM execution condition. The LTM cell switch procedure refers to the process of a UE switching (or changing) its cell from a source cell to the CLTM candidate cell. In the context of LTM, an LTM cell switch procedure may sometimes also be known as L1/L2 based inter-cell mobility execution, LTM execution, dynamic switch, LTM switch, (LTM) cell switch, (LTM) serving cell change, or (LTM) cell change. In the context of the invention, switching to the LTM candidate cell configuration comprises the UE considering that an LTM candidate cell becomes its new special cell (SpCell), e.g., Pcell in case of LTM being configured for a Master Cell Group (MCG) and/or PSCell in case of LTM being configured for a Secondary Cell Group (SCG), or the UE changing its SpCell from the current Pcell to an LTM candidate cell. In that sense, embodiments of the invention are applicable for the case in which the UE is configured with CLTM for the MCG (i.e., for the PCell) or/and for the case in which the UE is configured with CLTM for the SCG (i.e., for the PScell).

When the UE is configured with one or more CLTM candidate cells for the MCG, and one or more CLTM candidate cell(s) have the CLTM execution condition fulfilled, the UE selects a CLTM candidate cell to perform the CLTM execution and that cell is the cell to become the PCell.

When the UE is configured with one or more CLTM candidate cells for the SCG, and one or more CLTM candidate cell(s) have the CLTM execution condition fulfilled, the UE selects a CLTM candidate cell to perform the CLTM execution and that cell is the cell to become the PSCell.

Even if the term change of cell is used, that may comprise a change of a whole cell group configuration, which includes a change in the SpCell (e.g., change of Pcell, or change of PSCell) and a change in Scells of the cell group (e.g., addition, modification, and/or release, of one or more Scells).

In this context, when the UE selects a CLTM candidate cell which is a triggered CLTM candidate cell, i.e., the CLTM execution condition associated with the CLTM candidate cell is fulfilled, the UE evaluates which conditional LTM candidate cells fulfill the configured conditional criteria, and in case more than one conditional LTM candidate cell fulfills such criteria, the UE has to select to which conditional LTM candidate cell to perform a conditional LTM cell switch procedure and apply the associated conditional LTM candidate cell configuration.

For simplicity, throughout this disclosure the “network” is a network entity or network node from which the UE receives one or more configurations and/or parameters, such as the CLTM configuration for multiple CLTM candidate cells, and/or the network node which the UE accesses (e.g., Candidate gNB, candidate Distributed gNB) during CLTM execution, e.g., by transmitting a Scheduling Request over the Physical Uplink Control Channel (PUCCH) or a random access preamble.

According to embodiments of the invention, the UE is configured with multiple LTM candidate cell(s) (i.e., more than one candidate cell) and selects a subset of the LTM candidate cell(s)/at least one LTM candidate cell for transmitting a UL signal to a UL resource occasion (e.g., PRACH occasion) of the LTM candidate cell, wherein the UL resource occasion in which the UE transmits the UL signal occurs between the reception of the trigger and the first synchronization signal (e.g., SSB) of the LTM candidate cell after the trigger, wherein the selection of the subset of the LTM candidate cell(s) is based on one or more rules (or combination of these). In other words, the UE may not be able to perform the actions in the method for all configured cells, so the UE needs to select a subset of cells in which the UE performs the actions. Multiple rules, which may possibly be combined, are proposed below, for the selection of the subset of the LTM candidate cell(s).

According to embodiments of the invention, the UL signal may correspond to one or more of:
A PRACH preamble transmitted to a PRACH occasion of the LTM candidate cell in an LTM cell switch;
A PRACH preamble transmitted to a PRACH occasion of the LTM candidate cell in an TA establishment/update procedure;
A Sounding Reference Signal (SRS) transmitted to a PUCCH or PUSCH of the LTM candidate cell in an TA establishment/update procedure;
A control information (e.g., scheduling request) transmitted on a Physical Uplink Control Channel (PUCCH) of the LTM candidate cell in an LTM cell switch procedure; and/or
UL data (e.g., including as payload an RRC Reconfiguration Complete) transmitted on a Physical Uplink Shared Channel (PUSCH) of the LTM candidate cell in an LTM cell switch procedure.

According to embodiments of the invention, the UL resource occasion may correspond to one or more of:
A PRACH occasion of the LTM candidate cell;
A Physical Uplink Control Channel (PUCCH) resource or resource occasion of the LTM candidate cell which has been configured (e.g., in the RRC configuration of the LTM candidate cell) and/or assigned (e.g., in the LTM cell switch command);
A Physical Uplink Shared Channel (PUSCH) resource or resource occasion of the LTM candidate cell which has been configured (e.g., in the RRC configuration of the LTM candidate cell) and/or assigned (e.g., in the LTM cell switch command).

According to embodiments of the invention, the UE transmitting the UL signal to the LTM candidate cell in a configured UL channel resource(s) in time and frequency, such as a PRACH occasion happening between the reception of the trigger and the occurrence of the next synchronization signal (e.g., SSB) in the LTM candidate cell is based on DL synchronization performed before the reception of the trigger to the LTM candidate cell.

The UE performing DL synchronization (also called DL pre-synchronization, pre-synchronization, pre-sync) with an LTM candidate cell comprises the UE detecting and/or measuring at least one synchronization signal of the LTM candidate cell, such as an Synchronization Signal Block (SSB), e.g., an SSB of the LTM candidate cell associated to an SSB index and/or identifier and transmitted in a spatial direction (beam), and/or a Channel State Information-Reference Signal (CSI-RS) and/or a Tracking Reference Signal (TRS) and/or a Primary Sync Signal (PSS) and/or a Secondary Sync Signal (SSS). In this context, measuring comprises determining a measurement quantity value such as a Synchronization Signal based Reference Signal Received Power (SS-RSRP), a Synchronization Signal based Reference Signal Received Quality (SS-RSRQ), and/or a Synchronization Signal based Signal to Noise and Interference Ratio (SS-SINR).

The UE performing DL synchronization with an LTM candidate cell comprises the UE performing fine time tracking and acquiring full timing information of the LTM candidate cell. Timing acquisition comprises obtaining the time boundaries of time units of a given LTM candidate cell such as time slot, OFDM symbol, subframe, or radio frame. Timing acquisition comprises synchronizing a clock with the boundaries of time units of a given LTM candidate cell such as time slot, OFDM symbol, subframe, or radio frame. The acquired fine timing is used as reference point for PRACH transmission and UE uplink transmissions.

According to embodiments of the invention, the UE is configured with multiple LTM candidate cell(s) (i.e., more than one candidate cell) and selects a subset of the LTM candidate cell(s)/at least one LTM candidate cell for performing DL synchronization before a TA establishment procedure is triggered, wherein the selection of the subset of the LTM candidate cell(s) is based on one or more rules (or combination of these).

According to embodiments of the invention, the UE transmits the UL signal to the LTM candidate cell in a configured UL channel resource(s) in time and frequency before the next synchronization signal (e.g., SSB) of the LTM candidate cell, in the first configured UL channel resource(s) in time and frequency (e.g., first PRACH occasion) after the reception of the trigger.

The reason to transmit the UL signal in the first PRACH occasion configured for TA establishment, before the next synchronization signal, is that it would not be necessary in case the UE is DL synchronized with the LTM candidate cell, so that the UE can transmit in the next available PRACH occasion of the LTM candidate cell after the UE receives the trigger for TA establishment from the serving cell, e.g., a PDCCH order from the PCell.

According to embodiments of the invention, prior to receiving the LTM cell switch command from the serving cell indicating the LTM candidate cell, the UE receives a configuration (e.g., an LTM configuration within an RRC Reconfiguration message) from the serving cell with one or more LTM candidate cell configuration(s), to be applied upon reception of an LTM cell switch command. This is equivalent to the UE being configured with LTM by the network.

According to embodiments of the invention, prior to receiving the LTM cell switch command from the serving cell indicating the LTM candidate cell, the UE receives a configuration for TA establishment/update with the LTM candidate cell, comprising one or more UL related parameters such as PRACH preamble configuration, PRACH occasion(s), PRACH frequency resource(s), etc. The configuration for TA establishment/update may be included in the same RRC message configuring the UE with LTM, e.g., an RRC Reconfiguration. Alternatively, the configuration for TA establishment/update may be included in a second RRC message while the UE receives a first RRC message configuring the UE with LTM, e.g., a second RRC Reconfiguration.

According to embodiments of the invention, the UE is configured with multiple LTM candidate cell(s) and when the UE receives the trigger to transmit an uplink signal to an LTM candidate cell in a first subset of the multiple LTM candidate cell(s), the UE transmits the UL signal to the LTM candidate cell in a first subset of the multiple LTM candidate cell(s), in a configured UL channel resource(s) in time and frequency before the next synchronization signal (e.g., SSB) of the LTM candidate cell.

According to embodiments of the invention, the UE is configured with multiple LTM candidate cell(s) and when the UE receives the trigger from a serving cell (e.g., a PDCCH order from the Primary Cell, or Primary SCG cell) to transmit a UL signal (e.g., PRACH preamble) for TA establishment/update to an LTM candidate cell which is not in the first subset of the multiple LTM candidate cell(s), the UE transmits the UL signal to the LTM candidate cell which is NOT in the first subset of the multiple LTM candidate cell(s), in a configured UL channel resource(s) in time and frequency after the next synchronization signal (e.g., SSB) of the LTM candidate cell.

According to embodiments of the invention, the UE is configured with multiple LTM candidate cell(s) (i.e., more than one candidate cell) and selects a subset of the LTM candidate cell(s)/at least one LTM candidate cell for transmitting the UL signal (e.g., in a UL resource occasion between the reception of the trigger and the occurrence of an SSB), wherein the selection of the subset of the LTM candidate cell(s) is based on one or more rules (or combination of these), as follows:
1) The UE selects all LTM candidate cell(s) which the UE is configured with

In this case, the UE reports a capability which indicates that the UE is capable of DL synchronization with a number “K” of LTM candidate cells and the UE receives a message (e.g., RRC Reconfiguration) including an LTM configuration for a number “K*” LTM candidate cells with K*<=K, so the UE performs the UL transmission between the reception of the trigger and the next SSB occurrence (e.g., in a TA establishment or LTM cell switch) for all LTM candidates (or any, as a single one may be indicated in the LTM cell switch).

Note that there may be a first capability related to the TA establishment procedure and a second capability related to the LTM cell switch procedure.

This capability may be reported when the UE transitions from an IDLE state to a CONNECTED state.
2) The UE selects the strongest LTM candidate cells out of “N” configured LTM candidate cells according to a measurement quantity, wherein a measurement quantity may correspond to RSRP, RSRQ, SINR, etc

The measurement quantity may be RSRP, RSRQ, or SINR.

In this case, the strongest LTM candidate cells are selected based on the cell quality of the LTM candidate cells, e.g., UE selects the LTM candidates whose cell RSRP values are the strongest.

For example, the strongest LTM candidate cells may be selected based on a beam/SSB/CSI-RS quality of the LTM candidate cells, e.g., UE selects the LTM candidates whose strongest beam level RSRP values (SS-RSRP values) are the strongest.
3) The UE selects “K” strongest LTM candidate cells out of “N” configured LTM candidate cells according to a measurement quantity, wherein a measurement quantity may correspond to RSRP, RSRQ, SINR, etc

In this case, the UE reports a capability which indicates that the UE is capable of DL sync (or DL pre-sync) with a number “K” of LTM candidate cells and the UE receives a message (e.g., RRC Reconfiguration) including an LTM configuration for a number “N” LTM candidate cells with N >K, so that the UE transmits the UL signal in a UL resource occasion between the reception of the trigger and the next SSB occurrence to any of the K strongest LTM candidate cell(s) for a measurement quantity, after receiving the LTM candidate cell configuration and upon reception of the trigger (e.g., for TA establishment procedure or LTM cell switch).

The measurement quantity may be RSRP, RSRQ, or SINR.

The K strongest LTM candidate cells may be selected based on the cell quality of the LTM candidate cells, e.g., UE selects the LTM candidates whose cell RSRP values are the strongest.

Alternatively, the K strongest LTM candidate cells may be selected based on a beam/SSB/CSI-RS quality of the LTM candidate cells. For example, the UE may select the LTM candidates whose strongest beam level RSRP values (SS-RSRP values) are the strongest.
4) The UE selects all LTM candidate cell(s) configured for TA establishment/ update, e.g., upon reception of the RRC message including the TA establishment configuration, when the number of LTM candidate cell(s) configured for TA establishment/update do not exceed a UE capability corresponding to a maximum number of cells in which the UE is capable of DL sync before reception of the trigger

For example, when the UE reports a capability which indicates that the UE is capable of DL sync with a number “K” of LTM candidate cells and the UE receives a message (e.g., RRC Reconfiguration) including an LTM configuration including the TA establishment configuration for a number K* of LTM candidate cells with K*<=K, the UE may transmit to any of the LTM candidate cells, upon reception of the trigger, the UL signal in a UL resource occasion between the reception of the trigger and the next SSB occurrence.

This capability may be reported when the UE transitions from an IDLE state to a CONNECTED state.

There may also be a capability related to the LTM cell switch and another capability related to the TA establishment/update procedure.
5) The UE selects the LTM candidate cell(s) configured for TA establishment/ update with a measurement quantity (e.g., RSRP) which is strong enough, e.g., the UE selects the LTM candidate cell(s) configured for TA establishment with strong enough RSRP

The measurement quantity may be RSRP, RSRQ, or SINR.

The measurement quantity may be a cell-based measurement quantity, e.g., a cell RSRP for the LTM candidate cell.

The measurement quantity may be a beam/SSB/CSI-RS based measurement quantity. For example, the UE may select the cells whose strongest SS-RSRP is sufficient/adequate.
6) The UE selects “K” strongest LTM candidate cells configured for TA establishment out of “N” configured LTM candidate cells configured for TA establishment according to a measurement quantity, wherein a measurement quantity may correspond to RSRP, RSRQ, SINR, etc

In this case, the UE reports a capability which indicates that the UE is capable of DL sync before a TA establishment or LTM cell switch with a number “K” of LTM candidate cells configured for TA establishment and the UE receives a message (e.g., RRC Reconfiguration) including an LTM configuration for a number “N” LTM candidate cells with N>K, so that the UE transmits to any of the K strongest LTM candidate cells, upon reception of the trigger, the UL signal in a UL resource occasion between the reception of the trigger and the next SSB occurrence, for a measurement quantity.

The measurement quantity may be RSRP, RSRQ, or SINR.

The K strongest LTM candidate cells may be selected based on the cell quality of the LTM candidate cell, e.g., the UE selects the LTM candidates whose cell RSRP values are the strongest.

Alternatively, the K strongest LTM candidate cells may be selected based on a beam/SSB/CSI-RS quality of the LTM candidate cell, e.g., the UE selects the LTM candidates whose strongest beam level RSRP values (SS-RSRP values) are the strongest.
8) The UE selects one or more LTM candidate cell(s) based on latest L1 measurement reports, e.g., SS-RSRP of an LTM candidate cell which has been reported

In this case, the UE is configured to perform L1 measurements on one or more LTM candidate cells, e.g., CSI measurements, SS-RSRP measurements, etc. Then, the UE selects the LTM candidate cells for which the UE has transmitted the L1 reports. This is advantageous in that these are also the LTM candidate cells which are more likely to be requested from the network (e.g., S-DU) for TA establishment and/or LTM cell switch.

Optionally, the UE does that with a number of LTM candidate cells before its capability in terms of the number of cells for performing DL sync or pre-sync is exceeded.
9) The UE selects one or more LTM candidate cell(s) based on L3 measurements, e.g., cell based RSRP of an LTM candidate cell.

In this case, the UE is configured to perform L3 measurements on one or more LTM candidate cells, e.g., Radio Resource Management (RRM) measurements like L3 filtered cell based RSRP, RSRQ, or SINR. Then, the UE selects the LTM candidate cells for which the UE has transmitted a L3 measurement report, e.g., cells, fulfilling the condition(s) of an event configured in the reporting configuration e.g., an A3 or an A5 event. This is advantageous in that these cells fulfilling the condition(s) associated with event(s) may be configured as LTM candidate cells by the network and be requested from the network (e.g., S-DU) for TA establishment.

Optionally, the UE does that with a number of neighbor cells (which may be triggered cells) before its capability is exceeded, e.g., the UE reports a number of cells up to the number of LTM candidate cells in which the UE can perform DL sync before the TA establishment.

Optionally, the UE updates the neighbor cells (e.g., triggered cells) in which the UE performs DL sync, depending on the cells which are being reported.
12) UE selects cells in higher frequencies and/or in a specific frequency range, e.g., FR2 cells, as these could take longer to perform DL sync and/or to measure

In this case, the UE selects one or more LTM candidate cells (or a subset of the LTM candidate cells) whose SSB(s) are in high frequencies and/or in a specific frequency range (FR2).

This is advantageous in that for these cells it may take longer to obtain DL sync so that if the UE waits for the trigger to transmit the UL signal and first needs to perform DL sync, it can take too much time.
13) UE selects cells with “long” SSB periodicity

In this case, the UE performs DL sync for an LTM candidate cell (or a subset of the LTM candidate cells) whose SSB(s) are with long periodicity e.g., above 20 ms.

In one option as one of the examples, the long periodicity is configured (e.g., periodicity threshold), so that the UE performs DL sync to cells with periodicity longer than the configured value.

This is advantageous in that for these cells it may take longer to obtain DL sync so that if the UE waits for the trigger to transmit the UL signal and first needs to perform DL sync, it can take too much time.

According to embodiments of the invention, the one or more rules may be based on one or more parameters the UE is configured with. The UE may receive the configuration of the one or more parameters in an RRC Reconfiguration message, wherein the one or more parameters may be set for one or more LTM candidate cell(s).

In some embodiments of the invention, the UE receives a configuration of one or more LTM candidate cells. Then, the UE receives the LTM cell switch command, and in response to the LTM cell switch command the UE transmits a UL signal (e.g., HARQ control information) via a UL channel (e.g., PUCCH) to the LTM candidate cell, wherein the UL signal comprises a scheduling request for transmitting a Hybrid Automatic Repeat Request (HARQ) feedback.

In an embodiment of the invention, the UE receives the LTM cell switch command, and in response to the LTM cell switch command the UE receives information on a DL control channel (e.g., PDCCH) occasion (e.g., a given frame/subframe/time-slot/one or more OFDM symbols), such as a Downlink Control Indication (DCI) indicating a DL data channel (e.g., PDSCH) with downlink data, so that in response the UE needs to transmit a HARQ feedback. To transmit that HARQ feedback, the UE transmits the scheduling request on PUCCH. The DL control channel occasion occurs between the reception of the LTM cell switch and the first synchronization signal (e.g., SSB) of the LTM candidate cell after the trigger.

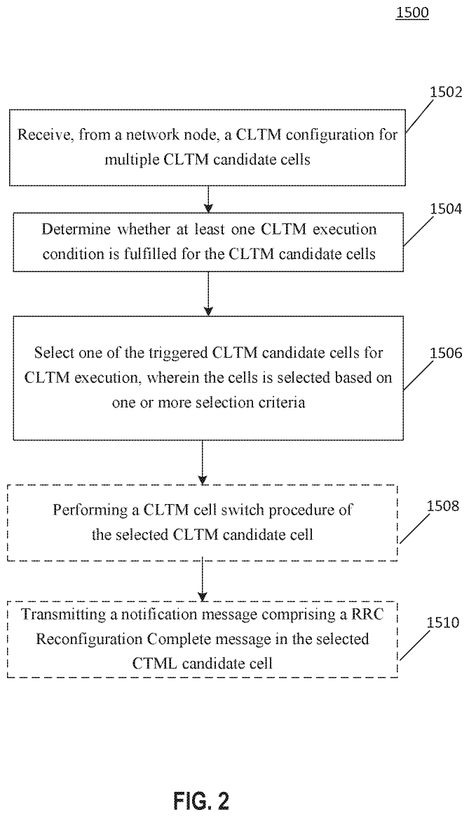

FIG. 2 is a flow chart illustrating an exemplary method 1500 for selecting a conditional L1/L2 triggered inter-cell mobility (CLTM) candidate cell. Referring to FIG. 2, in block 1502, the method includes receiving, from a network node, a CLTM configuration for multiple CLTM candidate cells, wherein the CLTM configuration comprises at least one or more CLTM candidate cell configurations and at least one or more CLTM execution conditions. In block 1504, the method includes determining whether at least one CLTM execution condition is fulfilled for the CLTM candidate cell. In block 1506, the method includes, in response to there being more than one triggered CLTM candidate cell, selecting one of the triggered CLTM candidate cells for CLTM execution, wherein the selected cells are selected based on one or more selection criteria. In block 1508, the method may optionally include performing a CLTM cell switch procedure of the selected CLTM candidate cell. In block 1510, the method may optionally include transmitting a notification message comprising a RRC Reconfiguration Complete message in the selected CTML candidate cell.

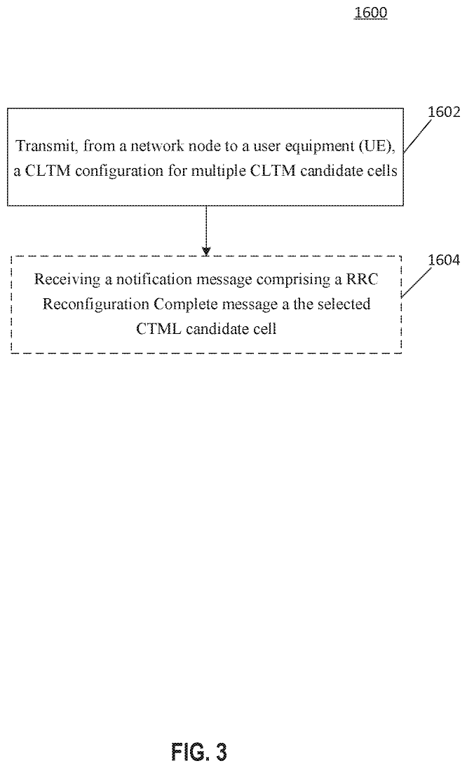

FIG. 3 is a flow chart illustrating an exemplary method 1600 performed by a network node for conditional L1/L2 triggered inter-cell mobility. Referring to FIG. 3, in block 1602, the method includes transmitting, from a network node to a UE, a CLTM configuration for multiple CLTM candidate cells, wherein the CLTM configuration comprises at least one or more CLTM candidate cell configurations and at least one or more CLTM execution conditions. In block 1604, the method may optionally include receiving a notification message comprising a RRC Reconfiguration Complete message a the selected CTML candidate cell.

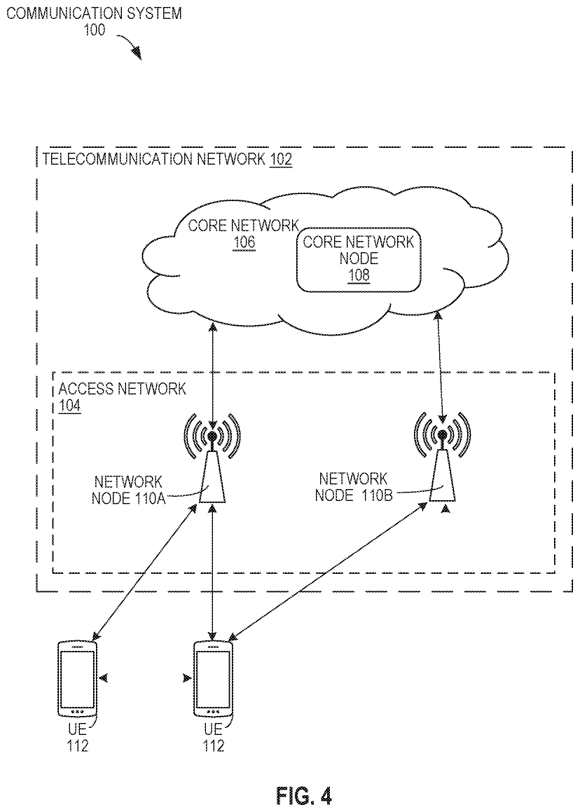

FIG. 4 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 102 includes one or more Open-RAN (ORAN) network nodes. An ORAN network node is a node in the telecommunication network 102 that supports an ORAN specification (e.g., a specification published by the O-RAN Alliance, or any similar organization) and may operate alone or together with other nodes to implement one or more functionalities of any node in the telecommunication network 102, including one or more network nodes 110 and/or core network nodes 108.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

As a whole, the communication system 100 of FIG. 4 enables connectivity between the UEs, network nodes, and one or more hosts which are under control of a service provider other than an operator or provider of the access network 104 and/or the telecommunication network 102. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

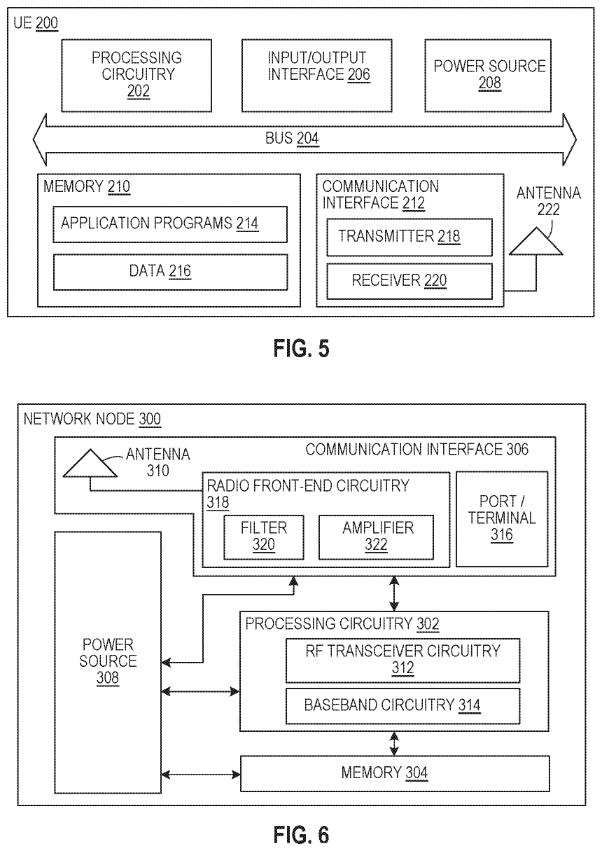

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card’.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 are integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In the following, further embodiments of the invention are described.

In some embodiments, the UE, after evaluating the CLTM execution conditions for all the CLTM candidate configurations, selects a CLTM candidate configuration among the ones for which the associated CLTM execution conditions are fulfilled applies the CLTM candidate cell configuration for the selected cell. In other words, if there is more than one CLTM candidate cell for which the CLTM execution conditions are fulfilled, the UE has to determine which CLTM candidate configuration to apply in order to perform a CLTM cell switch execution procedure.

The UE selects a CLTM candidate cell for which the associated CLTM execution condition is fulfilled and according to one or more rules comprising:
1) The UE selectively applies a CLTM candidate cell configuration for the selected cell according to the identifier of the CLTM candidate cell.
   In one example, the UE is configured with more than one CLTM candidate cell configuration. In this case, the UE considers the CLTM candidate cell configuration identifier in ascending order to establish the priority. For instance, when the CLTM candidate cell identifiers are from 1 to 8, the UE considers 1 to be the highest priority and 8 the lowest. Thus, when a subset of these CLTM candidate cells fulfills the associated CLTm execution conditions, e.g., CLTM candidate with identifier=5 and CLTM candidate with identifier=7, the UE selects the CLTM candidate cell 5, since 5 has higher priority compared to 7.
   In one example, the UE is configured with more than one CLTM candidate cell configuration. In this case, the UE considers the CLTM candidate cell configuration identifier in descending order to establish the priority. For instance, when the CLTM candidate cell identifiers are from 1 to 8, the UE considers 1 to be the lowest priority and 8 the highest. Thus, when a subset of these CLTM candidate cells fulfills the associated CLTm execution conditions, e.g., CLTM candidate with identifier =5 and CLTM candidate with identifier =7, the UE selects the CLTM candidate cell 7, since 7 has higher priority compared to 1.
   This works in case both the UE and the network are aware that the CLTM candidate identifier encodes this priority related information. In one option, the UE is indicated by the network how to interpret the identifier as a priority information, e.g., by using a field indicating a priority in ascending order or a field indicating a priority in descending order.
2) The UE selectively applies a CLTM candidate cell configuration for the selected cell according to the availability of Time Alignment and/or Timing Advance for the CLTM candidate cell.
   In one example, the UE selects the CLTM candidate configuration for which the UE has a valid Timing Advance (TA) value. In such a case, the TA value may have been received by the UE in a previous LTM Cell Switch Command or within a MAC CE. In one option, the rule is applicable when a Time Alignment timer, associated to the available TA value is running (i.e., the TA is valid). When the TA value is available, but the Time Alignment timer has expired or is stopped, the UE uses another rule for selecting a triggered cell.
   The benefit of selecting a configuration for which the UE has available TA value is that access may be much faster, since when there is a valid TA, the UE may avoid a random access procedure towards that cell.
   In one option, the UE receives the Timing Advance value for the CLTM candidate cell, e.g., in a MAC CE from the serving cell, in response to a Physical Random Access Channel (PRACH) preamble transmitted to the CLTM candidate cell.
   In one option, the UE calculates the Timing Advance value for the CLTM candidate cell, without the need to transmit a PRACH preamble to the CLTM candidate cell.
3) The UE selectively applies a CLTM candidate cell configuration for the selected cell according to the availability of a DL synchronization.
   If the UE has performed DL synchronization to the selected cell (e.g., pre-activation of one or more beams and/or TCI states of the selected cell), the UE selects to apply the associated CLTM candidate cell configuration.
   In one option, before the CLTM execution condition is fulfilled, the UE has received one or more MAC CEs from the network for activating one or more candidate Transmission Configuration Indication (TCI) state(s) for one or more CLTM candidate cells. These may be CLTM candidate cells the UE is considered to be DL synchronized with. In one option, being DL synchronized with a CLTM candidate cell comprises one or more of:
      i) Detecting and/or measuring at least one synchronization signal of the LTM candidate cell, such as an SSB of the LTM candidate cell associated to an SSB index and/or identifier and transmitted in a spatial direction (beam), and/or a CSI-RS and/or a TRS and/or a PSS and/or a SSS;
      ii) Performing fine time tracking and acquiring full timing information of the LTM candidate cell;
      iii) Obtaining the time boundaries of time units of a given LTM candidate cell such as time slot, OFDM symbol, subframe, radio frame;
      iv) Synchronizing a clock with the boundaries of time units of a given LTM candidate cell such as time slot, OFDM symbol, subframe, radio frame.
   The benefit is that the access towards a cell for which the UE has established DL synchronization is faster as it avoids the delay to establish DL sync.
   In one example, the UE has been provided with a command (e.g., MAC CE) to pre-activate a TCI state towards the cell before the UE has determined that the selected CLTM has fulfilled the conditional LTM execution condition.
   Another way to describe the rule is that the UE selects the CLTM candidate cell configuration for which at least one TCI state has been activated, e.g., for which the UE has received a MAC CE for activating a TCI state.
4) The UE selectively applies a CLTM candidate cell configuration for the selected cell according to whether the CLTM candidate cell configuration is also a non-conditional LTM candidate configuration.
   In one embodiment, the UE may decide to select an LTM candidate cell which is configured as “normal” LTM candidate cell and as “conditional” LTM candidate cell. The UE may determine that by identifying that the CLTM candidate cell configuration is also indicated to be a normal LTM candidate cell, e.g., configured in an Information Element (IE) for LTM and in an IE for CLTM.
   The benefit would be that the UE may rely also on the network to evaluate if an LTM cell switch procedure needs to be triggered towards this LTM candidate cell and thus the UE may evaluate other configured CLTM candidate cells.
5) The UE selectively applies a conditional LTM candidate cell configuration for the selected cell according to which order the conditional LTM candidate configuration has been received by the UE.
   In one example, the UE is configured with more than one CLTM candidate cell configuration(s). In this case, the UE considers the CLTM candidate cell configuration at the first position of the list as the configuration with the highest priority.
   In another example, if the UE has received more than one CLTM candidate cell configuration within the same message, the UE will consider the configuration as the one which the highest priority based on the order in which the ASN.1 fields or IEs are received from the network.
   In another example, if the UE has received more than one CLTM candidate cell configuration in multiple RRC Reconfiguration messages, the UE considers the CLTM candidate cell configurations received in the latest RRC Reconfiguration messages with higher priority than the CLTM candidate configurations received in a previous RRC Reconfiguration message.
6) The UE selectively applies a CLTM candidate cell configuration for the selected cell according to whether CA is configured.
   In one option, the UE selects a CLTM candidate cell configuration in which at least one SCell is configured. The benefit would be that UE will apply a configuration which already configures CA and thus UE will experience better capacity (performance will be better).
   In one option, the UE selects a CLTM candidate cell configuration in which there are no configured SCells. The benefit would be that UE will apply a configuration which does not contain SCells, which may be relevant in case of limited UE energy/power available and/or in case of lower traffic demands.
7) The UE selectively applies a CLTM candidate cell configuration for the selected cell according to the number of SCells configured.
   In one option, the UE selects a CLTM candidate cell configuration with the highest number of configured SCell(s) for the cell group (e.g., MCG) for which CLTM is being executed. The benefit would be that UE will experience CA with a higher number of carriers aggregated and thus better latency and capacity.
   In one option, the UE selects a CLTM candidate cell configuration with the lowest number of configured SCell(s) for the cell group (e.g., MCG) for which CLTM is being executed. The benefit would be lower UE energy/power consumption, since fewer measurements would be required, especially when the UE has low traffic demands.
8) The UE selectively applies a CLTM candidate cell configuration for the selected cell according to whether the SCells are activated or deactivated. The benefit for the UE would be that it will be able to operate in CA as soon as switching to the new selected cell, thus transmitting and receiving traffic over the “activated” SCells. If the SCells are deactivated the UE cannot really benefit from CA until the network does not activate one or more SCell(s) explicitly.
9) The UE selectively applies a CLTM candidate cell configuration for the selected cell according to whether DC is configured. The benefit would be that UE will apply a configuration which already configures DC from the moment the UE access the cell and thus UE will experience better capacity (performance will be better).
10) The UE selectively applies a CLTM candidate cell configuration for the selected cell according to whether a L2 reset should be performed or not. The benefit is that avoiding L2 reset may result in shorter interruption or less data loss compared to performing L2 reset.
11) The UE selectively applies a CLTM candidate cell configuration for the selected cell according to whether an early ASN.1 decoding and validity check is performed. The benefit is that, if the UE has already done the ASN.1 decoding and validity check on a configuration, this may result in short interruption or less data loss compared to do the ASN.1 decoding and validity check in the moment the configuration is applied by the UE.
12) The UE selectively applies a CLTM candidate cell configuration for the selected cell according to the strongest SSB reference signal.
   In one example, if the UE measures SSB reference signal on the more than one configured CLTM candidate cells, the UE selects the CLTM candidate cell based on the strongest SSB. Therefore, the UE will select the one with the first strongest SSB first, the one with the second strongest SSB as second, and so on. The benefit would be the UE will apply a configuration with may guarantee better capacity and latency.
13) The UE selectively applies a CLTM candidate cell configuration for the selected cell according to the strongest CSI-RS reference signal.
   In one example, if the UE measures CSI-RC reference signal on the more than one configured CLTM candidate cells, the UE selects the CLTM candidate cell based on the strongest CSI-RS. Therefore, the UE will select the one with the strongest CSI-RS first, the one with the second strongest CSI-RS as second, and so on. The benefit would be the UE will apply a configuration with may guarantee better capacity and latency.
14) The UE selectively applies a CLTM candidate cell configuration for the selected cell according to whether CFRA resources are available. The benefit is that using dedicated random access resource, the UE will experience a fast random access procedure and thus shorter interruption and data loss.
   For example, the UE selects to perform a CLTM cell switch when CFRA resources are configured for CLTM candidate cell configuration, but not for another CLTM candidate cell configuration even if random access needs to be executed for all configured CLTM candidate cell configurations. In that case, since all configurations are to be using random access, the UE selects the procedure to apply with CFRA resources configured.
15) The UE selectively applies a CLTM candidate cell configuration for the selected cell according to whether the SCG is activated or deactivated. The benefit for the UE would be that it will be able to operate in DC as soon as switching to the new selected cell, thus transmitting and receiving traffic over the “activated” SCG. If the SCG is deactivated the UE cannot really benefit from DC until the network does not activate the SCG explicitly.
16) The UE selectively applies a CLTM candidate cell configuration for the selected cell according to whether a certain feature is configured or not in the CLTM candidate cell configuration.
   In one embodiment, the UE decides to apply a configuration which comprise one or more features which improve a chosen criteria. For instance, the UE may select to apply a configuration with a high number of MIMO layers because it improves the performance. On the other side, the UE may decide to apply a configuration which configures DC, because is better from a robustness point of view. In another example, the UE may select to apply to apply a configuration with the minimum number of MIMO layers to improve robustness.
17) The UE selectively applies a CLTM candidate cell configuration conditional for the selected cell according to a function at the UE which generates random numbers, one for a first CLTM candidate cell configuration, one for a second CLTM candidate cell configuration, and so on.
18) The UE selectively applies a CLTM candidate cell configuration for the selected cell according to whether a CLTM candidate cell configuration is also a CHO candidate configuration.
   In one embodiment, the UE decides to apply a configuration whether either a CLTM switch execution, or a CHO execution can be executed, i.e., the conditions for conditional LTM and for CHO are both fulfilled. The benefit is that the UE may use different set of conditional criteria (with L1 and L3 measurements) to evaluate the applied configuration. Also, the CLTM candidate cell configuration and CHO configuration for the selected cell may configure different features and UE may choose to apply one or the other.
   In one embodiment, the UE decides to apply a CLTM configuration depending on the presence of a CHO configuration for that cell. The CHO conditions may in this case not need to be fulfilled.
19) The UE selectively applies a CLTM candidate cell configuration for the selected cell according to whether the UE has both L1 and L3 measurements configured for the conditional LTM candidate cell configuration. One of the benefits is that the UE will have the opportunity to perform either L1 measurements or L3 measurements after the CLTM cell switch procedure and this may give the opportunity to the network to perform other mobility procedure, such as L3 handover.
20) The UE selectively applies a CLTM candidate cell configuration for the selected cell according to whether the CLTM candidate cell configuration has a configured UL grant configured. One of the benefits is that the UE will have the opportunity right away send a completion message (e.g., RRCReconfigurationComplete message) to the selected cell without waiting for a grant from the network. This will make the CLTM cell switch procedure faster.
21) The UE selectively applies a CLTM candidate cell configuration for the selected cell according to whether the CLTM candidate cell configuration relies on the dynamic grant (no configured grant part of the CLTM candidate cell configuration).
   In one embodiment, if there is no opportunity to use a configured grant, the UE applies a configuration which has the shortest SR periodicity so the UE can send the SR (to get a dynamic grant from the network) much faster. This will speed up completion of the CLTM cell switch execution procedure.
22) The UE selectively applies a CLTM candidate cell configuration for the selected cell according to whether the UE has already performed a CLTM cell switch execution towards the CLTM candidate cell. One of the benefits is that the UE has already done the ASN.1 decoding and validity check of the applied configuration and this reduces the connection interruption during the CLTM cell switch procedure.
23) The UE selectively applies a CLTM candidate cell configuration for the selected cell according to the number of CLT execution condition criteria which are fulfilled by the CLTM candidate cell. One of the benefits is that the UE will have to evaluate fewer or more criteria to determine if a CLTM candidate configuration has fulfilled the criteria.
   In case a CLTM candidate cell configuration with fewer conditional criteria is selected, this means that it would be easier for a CLTM candidate cell configuration to fulfill these criteria and thus the triggering of a CLTM cell switch execution is faster (even if ping pong LTM cell switches may be experienced).
   In case a candidate CLTM candidate cell configuration with more conditional criteria is chosen, this means that it would be harder for a CLTM candidate cell configuration to fulfill these criteria and thus the triggering of a CLTM cell switch execution is slower. However, after switching to the new cell the UE may experience more stable condition and the risk of a new mobility procedure may be low.
24) The UE selectively applies a CLTM candidate cell configuration for the selected cell according to the order in which the UE started to evaluate criteria for a CLTM candidate cell configuration.
   In one embodiment, the UE applies the configuration from which the UE started first to evaluate the CLTM execution condition criteria. For instance, if the UE started to evaluate the criteria with a CLTM candidate cell configuration with ID 3, this is the configuration which will be applied first if this candidate cell and more XLTM candidate cell configurations fulfill the associated CLTM execution conditionals.
25) [intentionally missing]
26) The UE selectively applies a CLTM candidate cell configuration (for the SCG) for the selected cell according to whether the CLTM candidate cell configuration includes associated changes to the MCG configuration or not.
   In one embodiment, the UE is configured with more than one CLTM candidate cell configuration for the SCG, i.e., for which the candidate target cell is a candidate target PSCell and execution of the CLTM candidate cell configuration corresponds to a change of PSCell. When there are multiple CLTM candidate cells for which the associated CLTM execution conditions have been fulfilled, the UE selects the CLTM candidate cell depending on the changes to the MCG configuration that are included in the same configuration. In one example, the UE selects a configuration that does not include any associated changes to the MCG configuration. In one example, the UE selects the configuration that includes the least changes to the MCG configuration.
27) The UE selectively applies a CLTM candidate cell configuration for the selected cell according to whether the CLTM candidate cell configuration includes an SCG configuration.
   In one embodiment, the UE is configured with more than one CLTM candidate cell configuration for the MCG, i.e., for which the candidate target cell is a candidate target PCell and execution of the CLTM candidate cell configuration corresponds to a change of PCell. When there are multiple CLTM candidate cells for the MCG for which the associated conditional LTM execution condition have been fulfilled, the UE selects the CLTM candidate cell depending on whether the configuration includes an SCG configuration or not.
   In one alternative, the UE selects a configuration that does include an SCG configuration. In one example, this means that the UE selects a CLTM candidate cell configuration that leads to that the UE is in NR-DC after applying the configuration and executing the corresponding LTM cell switch.
   In one alternative, the UE selects a configuration that does not include any SCG configuration.
      In one example, the UE selects a CLTM candidate cell configuration that leads to that the UE is not in NR-DC after applying the configuration and executing the corresponding LTM cell switch.
      In one example, the UE selects a CLTM candidate cell configuration that leads to that the UE keeps the same SCG configuration that it had prior to applying the CLTM candidate cell configuration (and executing the corresponding LTM cell switch), i.e., so that the UE is still in NR-DC after performing the LTM cell switch.
   In one alternative, the UE selects a CLTM candidate cell configuration that includes a release of the SCG, i.e., where the SCG is released as part of the LTM cell switch for the MCG. In one example, the UE is then configured with Dual Connectivity (DC) prior to applying the selected CLTM candidate cell configuration, but is not configured with DC after applying the configuration and executing the corresponding LTM cell switch for the MCG.
   In one alternative the UE selects a CLTM candidate cell configuration that includes an SCG configuration (e.g., that mrdc-SecondaryCellGroupConfig in the RRCReconfiguration message is set to setup) which does not include the mrdc-ReleaseAndAdd indication. This corresponds to that the included SCG configuration is a delta configuration on top of the SCG configuration that the UE had before the LTM cell switch, or on top of a reference configuration for the SCG.
   In one alternative the UE selects a CLTM candidate cell configuration that includes an SCG configuration (e.g., that mrdc-SecondaryCellGroupConfig in the RRCReconfiguration message is set to setup) which includes the mrdc-ReleaseAndAdd indication. This corresponds to that the UE releases the SCG configuration (if any) that it had prior to applying the selected conditional LTM candidate cell configuration (and executing the corresponding LTM cell switch for the MCG) and then applies the new included SCG configuration. This corresponds to that the included SCG configuration does not need to be built on top of a previous SCG configuration for the UE (or on a reference configuration).
   In one alternative, the UE selects a CLTM candidate cell configuration for the MCG, which does not require a random access towards the SCG/PSCell as part of the LTM cell switch execution procedure. The UE may need to perform a random access towards the PSCell/SCG that the UE is configured with after the LTM cell switch for the MCG if that cell switch lead to a change of security key.
28) The UE selectively applies a CLTM candidate cell configuration for the selected cell according to whether the CLTM candidate cell configuration includes an SCG configuration where the target cell is the same as the current PSCell.
   In one embodiment, the UE is configured with more than one CLTM candidate cell configuration for the MCG, i.e., for which the candidate target cell is a candidate target PCell and execution of the CLTM candidate cell configuration corresponds to a change of PCell, that correspond to that the UE has an SCG after the LTM cell switch for the MCG. That the UE has an SCG after the LTM cell switch for the MCG may correspond to that the corresponding CLTM candidate cell configuration includes an SCG configuration or that it does not include any release of the SCG configuration.
   When there are multiple CLTM candidate cells for which the associated CLTM execution conditions are fulfilled for the MCG (leading to SCG configuration after the LTM cell switch), the UE selects the CLTM candidate cell depending on whether the UE is configured with the same PSCell after the LTM cell switch as before the applying the configuration and performing the LTM cell switch.
29) The UE selectively applies a CLTM candidate cell configuration for the selected cell according to the lowest Time Alignment and/or Timing Advance for the CLTM candidate cell.
30) The UE selectively applies a CLTM candidate cell configuration for the selected cell according to whether the CLTM candidate cell is a cell for which the UE is able to perform a 2 step RACH CLTM execution
   In one embodiment, the UE applies the CLTM candidate configuration based on whether the CLTM candidate cell is a cell for which the UE is able to perform a 2-step RACH CLTM execution. If RACH needs to be used, the benefits is that the access to the cell will be quicker compared to 4-step RACH.
31) The UE selectively applies a CLTM candidate cell configuration for the selected cell corresponding to the lowest ARFCN
   In one embodiment, the UE applies a CLTM candidate configuration based for the cell operating at the lowest ARFCN. The benefit is that the access to a cell which, to a certain degree of probability, is likely to offer a better coverage compared to other cells operating at higher frequencies.
32) The UE selectively discard CLTM candidate cell configurations, i.e., does not select, for the cells operating in shared spectrum
   In one embodiment, the UE discards CLTM candidate configuration for cells operating in shared spectrum. The benefit is to avoid Uplink or Downlink LBT issues that may occur when accessing the cell.
33) The UE selectively applies a CLTM candidate cell configuration for the selected cell corresponding to a certain Frequency Range (e.g., FR1, or FR2 in NR)
   In one embodiment, the UE applies a CLTM candidate cell configuration for a cell corresponding to a certain Frequency Range.
34) The UE selectively applies a CLTM candidate cell configuration for the selected cell according to whether the CLTM candidate cell operates in the same Frequency Range as the current serving cell
   In one embodiment, the UE applies a CLTM candidate cell configuration if the cell operates in the same Frequency Range as the current serving cell.
35) The UE selectively applies a CLTM candidate cell configuration for the selected cell according to whether by connecting to the CLTM candidate cell the UE can avoid using more than one transmission chain (or can use fewer transmission chains).
36) The UE selectively applies a CLTM candidate cell configuration for the selected cell according to whether a CLTM candidate cell configuration also comprises or is associated with a conditional PSCell addition or PSCell change configuration or a CLTM configuration for the SCG.
   In one embodiment the presence of a conditional PSCell addition or PSCell change configuration is sufficient for selecting the LTM candidate cell.
   In another embodiment, the condition(s) for the PSCell addition or PSCell change may need to be fulfilled for the UE to apply the LTM configuration.
   In another embodiment, the UE selects the LTM candidate PCell for which the selected cell comprises a CLTM configuration for PSCell(s).
   In another embodiment, the UE selects the candidate PCell which is associated with a conditional reconfiguration for the SCG, such as CPC, CPA or CLM.
   In another embodiment, the UE selects the candidate PCell which is not associated with a conditional reconfiguration for the SCG, such as CPC, CPA or CLM, i.e., the UE precludes those configurations when it selects the target configuration.
37) The UE selectively applies a CLTM candidate cell configuration for the selected cell according to whether the same security keys and/or sk-Counter are used in the target cell.
   Some target configurations have different security configurations, e.g., different security keys, different sk-Counter (SN Counter) than the source cell. In this embodiment, the UE chooses the CLTM candidate cell configuration which does not change the security configuration.
38) the UE selectively applies a CLTM candidate cell configuration for the selected cell according to the CLTM candidate cell configuration that has the strongest RSRP, RSRQ, SINR, or any other RRM measurement.
   In one embodiment, the UE selects a CLTM candidate cell depending on one measurement quantity, e.g., the cell with the highest RSRP.
   In another embodiment, the UE selects a CLTM candidate cell depending on multiple measurement quantities, e.g., the cell with the highest RSRP and the highest RSRQ.
   In another embodiment, multiple measurement quantities are considered, but one quantity is the determining quantity. In one example, two cells which both have high RSRP and high RSRQ are considered, but the UE selects the one with the highest RSRP. A third cell with only high RSRP is not considered for selection.
   In another embodiment, multiple measurement quantities are considered and the UE selectively applies a CLTM candidate cell for the cell that has the largest difference in RRM measurement quantities. If, e.g., cell 1 has slightly higher RSRP, but cell 2 much higher RSRQ, the UE selects cell 2.
39) The UE selectively applies a CLTM candidate cell configuration for the selected cell according to the CLTM candidate cell configuration that has the strongest RSRP, RSRQ, SINR, or any other RRM measurement, for which the network has configured the measurement quantity in condition(s). This comprises the UE selecting the cell with the highest margin to the execution condition(s) being fulfilled.
   In one embodiment, the UE selects the cell with the highest measurement quantity, for which the network has configured condition(s). If, e.g., the network has configured LTM execution conditions depending on RSRP values, the UE selects the cell with the highest RSRP value. If the network has configured LTM execution conditions depending on RSRQ values, the UE selects the cell with the highest RSRQ value.
40) The UE selectively applies a CLTM candidate cell configuration for the selected cell according to the order in which the condition(s) were fulfilled. The cell for which the execution condition is fulfilled first will be selected.
   In one embodiment, the UE selects the CLTM candidate cell depending on the order the execution conditions were fulfilled. In one option, the UE selects the candidate cell where the execution conditions were fulfilled first. In another option, the UE selects the candidate cell where the execution conditions were fulfilled last.
41) The UE selectively applies a CLTM candidate cell configuration for the selected cell according to the cell selection criteria being fulfilled.
   In one embodiment, the UE selects a cell which have the S-criterion for cell selection fulfilled. If multiple cells fulfil the cell selection criterion, the UE may use further methods described herein to further select the target cell.
42) The UE selectively applies a CLTM candidate cell configuration for the selected cell according to the cell reselection criteria, i.e., according to the cell which the UE would have chosen for cell reselection.
   In one embodiment, the UE selects the target candidate LTM cell depending on the cell reselection criterion, i.e., the cell that the UE would have selected for camping in RRC_IDLE or RRC_INACTIVE.
43) The UE selectively applies a CLTM candidate cell configuration for the cell for which the most recent lowest DL pathloss measurement(s) is(are) available.
44) The UE selectively applies a CLTM candidate cell configuration for the cells for which the most recent highest DL SINR (or DL SNR) measurement(s) is(are) available.
45) The UE selectively applies a CLTM candidate cell configuration for cells for which the TDD pattern is the same as the one of the currently serving cell.
46) The UE selectively restricts CLTM candidate cell configurations to avoid reconfiguration to (or reactivation of) CA wherein the cells comprised in in CA operates in different frequency ranges.
47) The UE selectively applies a CLTM candidate cell configuration for the LTM candidate cell for which the conditions have been fulfilled most recently.

### EMBODIMENTS

### Method by the UE

1. A method (1500) performed by a user equipment, UE, for selecting a conditional L1/L2 triggered inter-cell mobility, CLTM, candidate cell, the method comprising:
   receiving (1502), from a network node, a configuration for a CLTM candidate cell, wherein the configuration comprises at least one or more CLTM candidate cell configurations and at least one or more CLTM execution conditions;
   determining (1504) whether at least one CLTM execution condition is fulfilled for the at least one CLTM candidate cell; and
   in response to there being more than one triggered CLTM candidate cell, selecting (1506) one of the triggered CLTM candidate cells for CLTM execution, wherein the selected cells are selected based on one or more selection criteria.
2. The method of embodiment 1, wherein the configuration is a CLTM configuration.
3. The method of embodiments 1 or 2, wherein the configuration is a CLTM configuration for multiple CLTM candidate cells.
4. The method of any of embodiments 1 to 3, wherein the method comprises determining whether at least one or more CLTM execution conditions are fulfilled for the at least one or more CLTM candidate cells.
5. The method of any of embodiments 1-4, wherein the one or more selection criteria are based on one of more of:
the one or more configurations of the triggered CLTM candidate cells;
the one or more physical layer properties of the triggered CLTM candidate cells;
the property of an interruption time of a triggered CLTM candidate cell during CLTM execution;
the one or more radio conditions and/or one or more measurements of CLTM candidate cells; and
frequency information of the CLTM candidate cells and/or the SpCell.
6. The method of any of embodiments 1 or 5, wherein selecting one of the triggered CLTM candidate cells for CLTM execution comprises applying the CLTM candidate cell configuration to the selected CTML candidate cell.
7. The method of any of embodiments 1 to 6, wherein the method further comprises: performing (1508) a CLTM cell switch procedure of the selected CLTM candidate cell.
8. The method of any of embodiments 1 to 7, wherein the at least one CLTM candidate cell is a CLTM candidate cell for a Master Cell Group, MCG, or a Secondary Cell Group, SCG.
9. The method of any of embodiments 1 to 8, wherein a triggered CLTM candidate cell corresponds to CTML candidate cell that fulfills the CLTM execution condition.
10. The method of any of embodiments 1 to 9, wherein the method further comprises: transmitting (1510) a notification message comprising a RRC Reconfiguration Complete message in the selected CTML candidate cell.

### Method by the Network Node

11. A method (1600) performed by a network node for conditional L1/L2 triggered inter-cell mobility, the method comprising:
   transmitting (1602), from the network node to the UE, an configuration for a CLTM candidate cell, wherein the configuration comprises at least one or more CLTM candidate cell configurations and at least one or more CLTM execution conditions.
12. The method of embodiment 11, wherein the configuration is a CLTM configuration.
13. The method of embodiments 11 or 12, wherein the configuration is a CLTM configuration for multiple CLTM candidate cells.
14. The method of any of embodiments 11-13, further comprising:
   receiving (1604) a notification message comprising a RRC Reconfiguration Complete message a the selected CTML candidate cell.

### UE

15. A user equipment, UE, for selecting a conditional L1/L2 triggered inter-cell mobility, CLTM, candidate cell, comprising:
   processing circuitry configured to perform any of the steps of any of the embodiments 1-10; and
   power supply circuitry configured to supply power to the processing circuitry.

### Network Node

16. A network node for conditional L1/L2 triggered inter-cell mobility, CLTM, candidate cell, the network node comprising:
   processing circuitry configured to perform any of the steps of any of the embodiments 11-14; and
   power supply circuitry configured to supply power to the processing circuitry.

1. A method performed by a user equipment (UE) for selecting a conditional L1/L2 triggered inter-cell mobility (CLTM) candidate cell, the method comprising:
receiving, from a network node, a CLTM configuration comprising two or more CLTM candidate cell configurations and associated CLTM execution conditions;
determining whether at least two CLTM execution conditions are fulfilled; and
in response to there being more than one CLTM candidate cell for which the associated CLTM execution condition is fulfilled, selecting one of the CLTM candidate cells for which the associated CLTM execution conditions are fulfilled for CLTM execution based on availability of one or more of: Time Alignment for the CLTM candidate cell, Timing Advance (TA) for the CLTM candidate cell, or Downlink (DL) synchronization with the CLTM candidate cell.

2. The method of claim 1, wherein the CLTM candidate cell is selected for which the UE has a valid TA value.

3. The method of claim 2, wherein a TA value is valid when a Time Alignment timer associated with the TA value is running.

4. The method of claim 2, wherein the TA value is received in a previous L1/L2 triggered inter-cell mobility (LTM) Cell Switch Command.

5. The method of claim 2, wherein the TA value is received in a Medium Access Control (MAC) Control Element (CE).

6. The method of claim 5, wherein the MAC CE is received from a serving cell, in response to a Physical Random Access Channel (PRACH) preamble transmitted to the CLTM candidate cell.

7. The method of claim 1, wherein the CLTM candidate cell is selected for which at least one Transmission Configuration Indication (TCI) state has been activated.

8. The method of claim 7, further comprising receiving a Medium Access Control (MAC) Control Element (CE) for activating the at least one TCI state.

9. The method of claim 7, wherein the at least one TCI state was activated prior to the UE determining that the CLTM execution condition associated with the selected CLTM candidate cell is fulfilled.

10. The method of claim 7, wherein DL synchronization of the UE with the CLTM candidate cell comprises one or more of:
detecting at least one synchronization signal of the CLTM candidate cell,
measuring at least one synchronization signal of the CLTM candidate cell,
performing fine time tracking and acquiring full timing information of the CLTM candidate cell,
obtaining time boundaries of time units of the CLTM candidate cell, or
synchronizing a clock with the time boundaries of time units of the CLTM candidate cell.

11. The method of claim 7, wherein the CLTM candidate cell is selected from a subset of the CLTM candidate cells with Synchronization Signal Blocks (SSBs) in the FR2 frequency range.

12. The method of claim 1, wherein selecting one of the CLTM candidate cells for which the associated CLTM execution conditions are fulfilled for CLTM execution comprises applying the CLTM candidate cell configuration for the selected CLTM candidate cell.

13. The method of claim 1, the method further comprising performing a CLTM cell switch procedure to the selected CLTM candidate cell.

14. The method of claim 1, wherein the at least one CLTM candidate cell is a CLTM candidate cell for a Master Cell Group (MCG) or a Secondary Cell Group (SCG).

15. The method of claim 1, the method further comprising transmitting a Radio Resource Control (RRC) Reconfiguration Complete message in the selected CLTM candidate cell.

16. A user equipment (UE) for selecting a conditional L1/L2 triggered inter-cell mobility (CLTM) candidate cell, comprising:
processing circuitry;
power supply circuitry configured to supply power to the processing circuitry;
a memory storing instructions which, when executed by the processing circuitry, cause the UE to perform the steps of:
receiving, from a network node, a CLTM configuration comprising two or more CLTM candidate cell configurations and associated CLTM execution conditions;
determining whether at least two CLTM execution conditions are fulfilled; and
in response to there being more than one CLTM candidate cell for which the associated CLTM execution condition is fulfilled, selecting one of the CLTM candidate cells for which the associated CLTM execution conditions are fulfilled for CLTM execution based on availability of one or more of: Time Alignment for the CLTM candidate cell, Timing Advance (TA) for the CLTM candidate cell, or Downlink (DL) synchronization with the CLTM candidate cell.

17. The UE of claim 16, wherein the CLTM candidate cell is selected for which the UE has a valid TA value.

18. The UE of claim 17, wherein a TA value is valid when a Time Alignment timer associated with the TA value is running.

19. The UE of claim 17, wherein the TA value is received in a previous L1/L2 triggered inter-cell mobility (LTM) Cell Switch Command.

20. The UE of claim 17, wherein the TA value is received in a Medium Access Control (MAC) Control Element (CE).

21. The UE of claim 20, wherein the MAC CE is received from a serving cell, in response to a Physical Random Access Channel (PRACH) preamble transmitted to the CLTM candidate cell.

22. The UE of claim 16, wherein the CLTM candidate cell is selected for which at least one Transmission Configuration Indication (TCI) state has been activated.

23. The UE of claim 22, further comprising receiving a Medium Access Control (MAC) Control Element (CE) for activating the at least one TCI state.

24. The UE of claim 22, wherein the at least one TCI state was activated prior to the UE determining that the CLTM execution condition associated with the selected CLTM candidate cell is fulfilled.

25. The UE of claim 22, wherein DL synchronization of the UE with the CLTM candidate cell comprises one or more of:
detecting at least one synchronization signal of the CLTM candidate cell,
measuring at least one synchronization signal of the CLTM candidate cell,
performing fine time tracking and acquiring full timing information of the CLTM candidate cell,
obtaining time boundaries of time units of the CLTM candidate cell, or
synchronizing a clock with the time boundaries of time units of the CLTM candidate cell.

26. The UE of claim 22, wherein the CLTM candidate cell is selected from a subset of the CLTM candidate cells with Synchronization Signal Blocks (SSBs) in the FR2 frequency range.

27. The UE of claim 16, wherein selecting one of the CLTM candidate cells for which the associated CLTM execution conditions are fulfilled for CLTM execution comprises applying the CLTM candidate cell configuration for the selected CLTM candidate cell.

28. The UE of claim 16, wherein the instructions, when executed by the processing circuitry, further cause the UE to perform the step of: performing a CLTM cell switch procedure to the selected CLTM candidate cell.

29. The UE of claim 16, wherein the at least one CLTM candidate cell is a CLTM candidate cell for a Master Cell Group (MCG) or a Secondary Cell Group (SCG).

30. The UE of claim 16, wherein the instructions, when executed by the processing circuitry, further cause the UE to perform the step of: transmitting a Radio Resource Control (RRC) Reconfiguration Complete message in the selected CLTM candidate cell.
